(19) United States
(12) Patent Application Publication
(10) Pub. No.: US 2017/0054176 A1
(43) Pub. Date: Feb. 23, 2017

(54) ANODE COMPOSITIONS FOR SODIUM-ION BATTERIES AND METHODS OF MAKING SAME

(71) Applicant: 3M INNOVATIVE PROPERTIES COMPANY, St. Paul, MN (US)

(72) Inventors: Mark N. Obrovac, Nova Scotia (CA); Zachary L. Brown, Nova Scotia (CA); Ryan I. Fielden, Nova Scotia (CA); Stephanie A. Smith, Ontario (CA)

(21) Appl. No.: 15/307,063

(22) PCT Filed: Apr. 29, 2015
(86) PCT No.: PCT/US15/28121

§ 371 Date: Oct. 27, 2016

Related U.S. Application Data
(60) Provisional application No. 61/987,789, filed on May 2, 2014.

(51) Int. Cl. H01M 10/054; H01M 4/485; H01M 4/505; H01M 10/0568; C01G 31/00; C01G 53/00; C01G 51/00; C01G 49/00; C01G 45/12; C01G 37/00; H01M 4/525; H01M 10/058

(52) U.S. Cl. CPC H01M 10/054; H01M 4/525; H01M 4/485; H01M 4/505; H01M 10/0568; H01M 10/058; C01G 53/40; C01G 51/40; C01G 49/0081; C01G 51/66; C01G 45/12; C01G 37/006; C01G 31/006; C01P 2006/40; C01P 2002/72; C01P 2002/76

(57) ABSTRACT

A sodium-ion battery includes a cathode comprising sodium; and an anode composition comprising a material having the formula: AₐB_{b}C_{c}D_{d}O, where A is an alkali metal, alkaline earth metal, or a combination thereof, where B is titanium, C is vanadium, D is one or more transition metal element other than titanium or vanadium, a+b+c+d≦1, a≧0, b+c>0, b≧0, c≧0, d>0, and where the material comprises a ilmenite structure, triclinic VFeO₄ structure, cubic Ca₅Co₄(VO₄)₆ structure, dichromate structure, orthorhombic ∀-CoV₃O₈ structure, brannerite structure, thortveitite structure, orthorhombic ∃-CrPO₄ structure, or the pseudo rutile structure.

### FIELD

The present disclosure relates to compositions useful as anodes for sodium-ion batteries and methods for preparing and using the same.

### BACKGROUND

Various anode compositions have been introduced for use in secondary sodium-ion batteries. Such compositions are described, for example, in Jiang Wei Wang et,al, “Microstructural Evolution of Tin Nanoparticles during In Situ Sodium Insertion and Extraction”, Nano Letters; Yunhua Xu et. Al, “Electrochemical Performance of Porous Carbon/Tin Composite Anodes for Sodium-Ion and Lithium-Ion Batteries”, Advanced Energy Materials; Lifen Xiao et. al, “High capacity, reversible alloying reactions in SnSb/C nanocomposites for Na-ion battery applications”, Chem. Comm. 48 (2012) 3321; U.S. Patent Application Publication No. 2012/0199785; Tuan T. Tran et. al, “Alloy Negative Electrodes for High Energy Density Metal-Ion Cells”, J. Electrochem. Soc. 158 (2011) A1411; V. L. Chevrier et al., “Challenges for Na-ion Negative Electrodes”, J. Electrochem. Soc. 158 (2011) A1011, and Shanmugan et al., “Na2/3Ni1/3Ti2/3O2: “Bi-Functional” Electrode Materials for Na-Ion Batteries”, Electrochem. Lett., 3 (2014) A23.

### SUMMARY

In some embodiments, a sodium-ion battery is provided. The sodium-ion battery includes a cathode comprising sodium; and an anode composition comprising a material having the formula:

AₐB_{b}C_{c}D_{d}O, (I)

where A is an alkali metal, alkaline earth metal, or a combination thereof, where B is titanium, C is vanadium, D is one or more transition metal element other than titanium or vanadium, a+b+c+d≦1, a≧0, b+c>0, b≧0, c≧0, d>0, and where the material comprises a ilmenite structure, triclinic VFeO₄ structure, cubic Ca₅Co₄(VO₄)₆ structure, dichromate structure, orthorhombic ∀-CoV₃O₈ structure, brannerite structure, thortveitite structure, orthorhombic ∃-CrPO₄ structure, or the pseudo rutile structure.

In some embodiments, a sodium-ion battery is provided. The sodium-ion battery includes a cathode comprising sodium; and an anode composition comprising a material having the formula:

A′ₑB′_{f}C′_{g}O, (II)

where A′ is an alkali metal, alkaline earth metal, or a combination thereof, where B′ is titanium, C′ is vanadium, e+f+g≦1, e≧0, f>0, and g>0.

In some embodiments, a method of making a sodium-ion battery is provided. The method includes providing a cathode comprising sodium and an anode. The anode includes vanadium, titanium, or a combination thereof, and optionally an alkali metal or alkaline earth metal and optionally a transition metal other than titanium or vanadium. The method further includes incorporating the cathode and anode into a battery comprising an electrolyte that includes sodium.

In some embodiments, a sodium-ion battery is provided. The sodium-ion battery includes a cathode comprising sodium; and an anode composition comprising one or more materials selected from CoTiO₃, Ca₅Co₄(VO₄)₆, CoV₃O₈, NiTiO₃, Co₂V₂O₇ or MnV₂O₆.

The above summary of the present disclosure is not intended to describe each embodiment of the present invention. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 depicts an XRD pattern of a Fe₂TiO₅ material with a pseudobrookite structure;

FIG. 2 depicts the voltage capacity curve of the Fe₂TiO₅ material of FIG. 1;

FIG. 3 depicts an XRD pattern of a NiTiO₃ material with an ilmenite structure.

FIG. 4 shows the voltage capacity curve of the NiTiO₃ material of FIG. 3.

FIG. 5A shows the experimental XRD pattern of Example 2, and the known peak positions of CoTiO₃ indicated by diamonds (Powder Diffraction File (PDF)#00-15-0866); and FIG. 5B shows the corresponding voltage curve for a cell made with the material of Example 2.

FIG. 6A shows the experimental XRD pattern of Example 3, and the known peak positions of VFeO₄ indicated by diamonds (PDF#00-38-1372); and FIG. 6B shows the corresponding voltage curve for a cell made with the material of Example 3.

FIG. 7A shows the experimental XRD pattern of Example 4, and the known peak positions of Ca₅Co₄(VO₄)₆ indicated by diamonds (PDF#00-052-1884); and FIG. 7B shows the corresponding voltage curve for a cell made with the material of Example 4.

FIG. 8A shows the experimental XRD pattern of Example 5, and the known peak positions Co₂V₂O₇ indicated by diamonds (PDF#00-038-0193); and FIG. 8B shows the corresponding voltage curve for a cell made with the material of Example 5.

FIG. 9A shows the experimental XRD pattern of Example 6, and the known peak positions CoV₃O₈ indicated by diamonds (PDF#00-022-0598); and FIG. 9B shows the corresponding voltage curve for a cell made with the material of Example 6.

FIG. 10A shows the experimental XRD pattern of Example 7, and the known peak positions MnV₂O₆ indicated by diamonds (PDF#00-35-0139); and FIG. 10B shows the corresponding voltage curve for a cell made with the material of Example 7.

FIG. 11A shows the experimental XRD pattern of Example 8, and the known peak positions Mn₂V₂O₇ indicated by diamonds (PDF#00-073-1806); and FIG. 11B shows the corresponding voltage curve for a cell made with the material of Example 8.

FIG. 12A shows the experimental XRD pattern of Example 9, and the known peak positions MnTiO₃ indicated by diamonds (PDF#00-089-3742); and FIG. 12B shows the corresponding voltage curve for a cell made with the material of Example 9.

FIG. 13A shows the experimental XRD pattern of Example 10, and the known peak positions CrVO₄ indicated by diamonds (PDF#00-038-1376); and FIG. 13B shows the corresponding voltage curve for a cell made with the material of Example 10.

FIG. 14A shows the experimental XRD pattern of Example 11, and the known peak positions TiVO₄ indicated by diamonds (PDF#00-077-0332); and FIG. 14B shows the corresponding voltage curve for a cell made with the material of Example 11.

### DETAILED DESCRIPTION

Sodium-ion batteries are of interest as a low-cost, high energy density battery chemistry for use in, for example, electric vehicles or stationary grid storage applications. Hard carbons have been suggested as suitable negative electrode materials for use in sodium-ion batteries. However, hard carbons have volumetric capacities of only about 450 Ah/L, or about less than two-thirds the volumetric capacity of graphite in a lithium-ion cell.

It has been shown that sodium can insert into metal oxides, such as CuO, at low voltages. However, such metal oxides typically undergo displacement (or conversion) reactions of the type:

2Na+CuO→Cu+Na₂O

While these reactions are reversible, electrodes incorporating such metal oxides as an active anode material have had low efficiency and short cycle life.

It has also been shown that sodium can insert into titanates (e.g. Na₂Ti₃O₇), at low voltage. The mechanism for sodiation in this material is via a reversible intercalation mechanism. However, Na₂Ti₃O₇ is a white insulating powder, which is typical of titanates. Such materials do not function in an electrode unless ground to a small size and combined with a large amount of carbonaceous material (e.g., carbon black). As a result, electrodes made with such materials are thought to have low volumetric capacity. Consequently, negative electrode materials for use in sodium-ion batteries that are not associated with the above-described deficiencies are desirable.

Surprisingly, it has been discovered that certain transition metal titanates and vanadium oxides can operate as efficient negative electrodes for sodium ion batteries at low voltages without the need for large amounts of carbonaceous material. Specifically, it was discovered that certain transition metal titanates and vanadium oxides sodiate via highly reversible reactions.

### DEFINITIONS

In this document:

the terms “sodiate” and “sodiation” refer to a process for adding sodium to an electrode material;

the terms “desodiate” and “desodiation” refer to a process for removing sodium from an electrode material;

the terms “charge” and “charging” refer to a process for providing electrochemical energy to a cell;

the terms “discharge” and “discharging” refer to a process for removing electrochemical energy from a cell, e.g., when using the cell to perform desired work;

the term “cathode” refers to an electrode (often called the positive electrode) where electrochemical reduction and sodiation occurs during a discharging process;

the term “anode” refers to an electrode (often called the negative electrode) where electrochemical oxidation and desodiation occurs during a discharging process;

the term “alloy” refers to a substance that includes any or all of metals, metalloids, semimetals; and

the term “powder” refers to a material which exists in a particulate form comprising a plurality of particles wherein the average size of the particles is below 200 micrometers.

As used herein, PDF#s may be understood with reference to the International Centre for Diffraction Data PDF-2, Release 2002.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure relates to an anode composition for a sodium ion battery. The anode composition may include a material having the formula:

AₐB_{b}C_{c}D_{d}O, (I)

where A is an alkali metal, alkaline earth metal, or a combination thereof, where B is titanium, C is vanadium, and D is one or more transition metal element other than titanium or vanadium, O is oxygen, a+b+c+d≦1, a≧0, b+c>0, b≧0, c≧0, d>0, and where the material has a ilmenite structure, triclinic VFeO₄ structure, cubic Ca₅Co₄(VO₄)₆ structure, dichromate structure, orthorhombic ∀-CoV₃O₈ structure, brannerite structure, thortveitite structure, orthorhombic ∃-CrPO₄ structure, or the pseudo rutile structure. In various embodiments, (b+c)/d≧1, 2, or 3; a=0, or >0.05, 0.1 or 0.2; a+b+c+d<1, 0.7, 0.6, or =0.5; b+c>0.2, 0.3, 0.4, or =0.5. In illustrative embodiments, D is nickel, cobalt, manganese, iron, chromium or a combination thereof. In some embodiments, b>0 and c=0. In some embodiments, b=0 and c>0. In some embodiments, b>0 and c>0. In various embodiments, A is sodium, lithium, magnesium or calcium.

The anode composition may further include a material having the formula:

A′ₑB′_{f}C′_{g}O, (II)

where A′ is an alkali metal, alkaline earth metal, or a combination thereof, where B′ is titanium, C′ is vanadium, O is oxygen, e+f+g≦1, e≧0, f>0, and g>0. In various embodiments, A′ is sodium, lithium, magnesium or calcium. In some embodiments the material has the pseudo rutile structure.

In illustrative embodiments, specific examples of anode compositions may include those having the formulae CoTiO₃, Ca₅Co₄(VO₄)₆, CoV₃O₈, NiTiO₃, CO₂V₂O₇ or MnV₂O₆.

In some embodiments, the anode compositions of the present disclosure may further include one or more additives such as binders, conductive diluents, fillers, adhesion promoters, thickening agents for coating viscosity modification such as carboxymethylcellulose, polyacrylic acid, polyvinylidene fluoride, lithium polyacrylate, carbon black, and other additives known by those skilled in the art. In some embodiments, the anode compositions of the present disclosure may further include other active anode materials, such as hard carbons (up to 10 wt. %, 20 wt. %, 50 wt. % or 70 wt. %, based on the total weight of electrode components, excluding the current collector) as described in D. A. Stevens and J. R. Dahn, J. Electrochem. Soc., 148 (2001) A803.

In some embodiments, anodes comprising the electrochemically active anode materials of the present disclosure may can have high specific capacity (mAh/g) retention (i.e., improved cycle life) when incorporated into a sodium ion battery and cycled through multiple charge/discharge cycles. For example, such anodes can have a specific capacity of greater than 50 mAh/g, greater than 100 mAh/g, greater than 500 mAh/g, or even greater than 1000 mAh/g when the battery is cycled between 0 and 2V or 5 mV and 1.2V vs. Na and the temperature is maintained at about room temperature (25° C.) or at 30° C. or at 60° C. or even higher.

The present disclosure further relates to methods of making the above-described anode compositions. Exemplary anode compositions can be prepared by any known method, for example, by heating precursor materials in a furnace, typically at temperatures above 300° C. The atmosphere during the heating process is not limited. The atmosphere can be air, an inert atmosphere, a reducing atmosphere such as one containing hydrogen gas, or a mixture of gases. The precursor materials are also not limited. Suitable precursor materials can be one or more metal oxides, metal carbonates, metal nitrates, metal sulfates, metal chlorides or combinations thereof. Such precursor materials can be combined by grinding, mechanical milling, precipitation from solution, or by other methods known in the art. The precursor material can also be in the form of a sol-gel. After firing, the oxides can be treated with further processing, such as by mechanical milling to achieve an amorphous or nanocrystalline structure, grinding and particle sizing, surface coating, and by other methods known in the art. Exemplary anode compositions can also be prepared by mechanical milling of precursor materials without firing. Suitable milling can be done by using various techniques such as vertical ball milling, horizontal ball milling, or other milling techniques known to those skilled in the art.

The present disclosure further relates to methods of making an electrode for a sodium-ion battery. In some embodiments, the method may include mixing the above-described the anode material, along with any additives such as binders, conductive diluents, fillers, adhesion promoters, thickening agents for coating viscosity modification and other additives known by those skilled in the art, in a suitable coating solvent such as water or N-methylpyrrolidinone to form a coating dispersion or coating mixture. The dispersion may be mixed thoroughly and then applied to a foil current collector by any appropriate coating technique such as knife coating, notched bar coating, dip coating, spray coating, electrospray coating, or gravure coating. The current collectors may be thin foils of conductive metals such as, for example, copper, aluminum, stainless steel, or nickel foil. The slurry may be coated onto the current collector foil and then allowed to dry in air or vacuum, and optionally by drying in a heated oven, typically at about 80° to about 300° C. for about an hour to remove the solvent.

In various embodiments, the electrodes of the present disclosure may be particularly useful as negative electrodes for sodium-ion batteries. To prepare a battery, the negative electrode may be combined with an electrolyte and a cathode. Examples of suitable cathodes include sodium containing cathodes, such as sodium transition metal oxides of the formula NaₓMO₂, were M is a transition metal and x is from 0.7 to 1.2. Specific examples of suitable cathode materials include NaCrO₂, NaCoO₂, NaNi_{0.5}Mn_{0.5}O₂, NaMn_{0.5}Fe_{0.5}O₂. The electrolyte may be in the form of a liquid, solid, or gel. Electrolytes normally comprise a salt and a solvent. Examples of solid electrolyte solvents include polymers such as polyethylene oxide, polytetrafluoroethylene, fluorine-containing copolymers, and combinations thereof. Examples of liquid electrolyte solvents include ethylene carbonate, diethyl carbonate, propylene carbonate, fluoroethylene carbonate, and combinations thereof. Examples of electrolyte salts include sodium containing salts, such as NaPF₆ and NaClO₄, Na[N(SO₂CF₃)₂]₂, NaCF₃SO₃ and NaBF₄. A microporous separator, such as a microporous material available from Celgard LLC, Charlotte, N.C., may be incorporated into the battery and used to prevent the contact of the negative electrode directly with the positive electrode.

The disclosed electrochemical cells can be used in a variety of devices including, without limitation, portable computers, tablet displays, personal digital assistants, mobile telephones, motorized devices (e.g., personal or household appliances and vehicles), instruments, illumination devices (e.g., flashlights) and heating devices. One or more electrochemical cells of this invention can be combined to provide battery pack.

The operation of the present disclosure will be further described with regard to the following detailed examples. These examples are offered to further illustrate various specific embodiments and techniques. It should be understood, however, that many variations and modifications may be made while remaining within the scope of the present disclosure.

### EXAMPLES

### Comparative Example 1

### Preparation of Fe₂TiO₅ (Pseudobrookite Structure)

To prepare Fe₂TiO₅, 4.00 g Fe₂O₃ (5 μm, ≧99%, Sigma-Aldrich), and 2.00 g TiO₂ (puriss, 99-100.5%, Sigma-Aldrich) were added to a 40 ml ball milling vial. Stoichiometric amounts of each compound were used. The precursors were ball milled for a half hour in a high energy ball mill (Spex Certiprep). The powders were then heated at 1000° C. in argon for 24 hours. After synthesis, samples were transferred directly to an argon filled glove box without air exposure.

The samples were characterized by X-ray powder diffraction (XRD) using a Rigaku Ultima IV X-Ray Diffractometer equipped with a Cu anode X-ray tube and dual detectors. A scintillation detector with a diffracted beam monochromator was used to measure XRD patterns of the powder sample.

The powder XRD sample was loaded into a gas tight X-ray sample holder (DPM Solutions, Hebbville NS) in an argon-filled glovebox. The sample holder had an aluminized Mylar window mounted in an arc such that it was perpendicular to the incident and scattered X-ray beam and did not contribute to the measured XRD patterns. The X-ray sample holder was equipped with gas fittings that allowed a continuous flow of helium gas during the XRD measurements. Rietveld refinement and profile matching of the powder diffraction data of the as prepared powders were performed using Rietica software. By this method it was determined that the prepared Fe₂TiO₅ sample had the pseudobrookite structure.

2325 type coin cells were assembled to evaluate electrochemical performance in sodium cells. Electrodes consisted of the Fe₂TiO₅ samples, carbon black (Super P, Erachem Europe), and PVDF (polyvinylidene fluoride, Kynar HSV 900) in an 8:1:1 weight ratio. These components were thoroughly mixed in N-methyl-2-pyrrolidone (Sigma Aldrich, anhydrous 99.5%) with two tungsten carbide balls in a Retsch PM200 rotary mill (100 rpm, 1 hour) to create a uniform black slurry. The slurry was then coated onto aluminum foil and dried under vacuum at 120° C. for 2 hours. Circular electrodes, 2 cm² in area, were punched from the resulting coatings. Coin cell preparation was carried out in an argon filled glove box. Sodium foil disk anodes were punched from thin foil (0.015 inch) that was rolled from sodium ingot (Sigma Aldrich, ACS reagent grade). The electrolyte was 1 M NaPF₆ (Sigma Aldrich 98%) dissolved in propylene carbonate (Novolyte Technologies). One Celgard 3501 and one BMF (blown microfiber separator, 3M Company) were used as separators. Cells were tested on a Maccor Series 4000 Automated cycler and were cycled at a constant current of C/10, calculated based on a 112 mAh/g capacity for voltage cycling from 0.005 to 4.3 V.

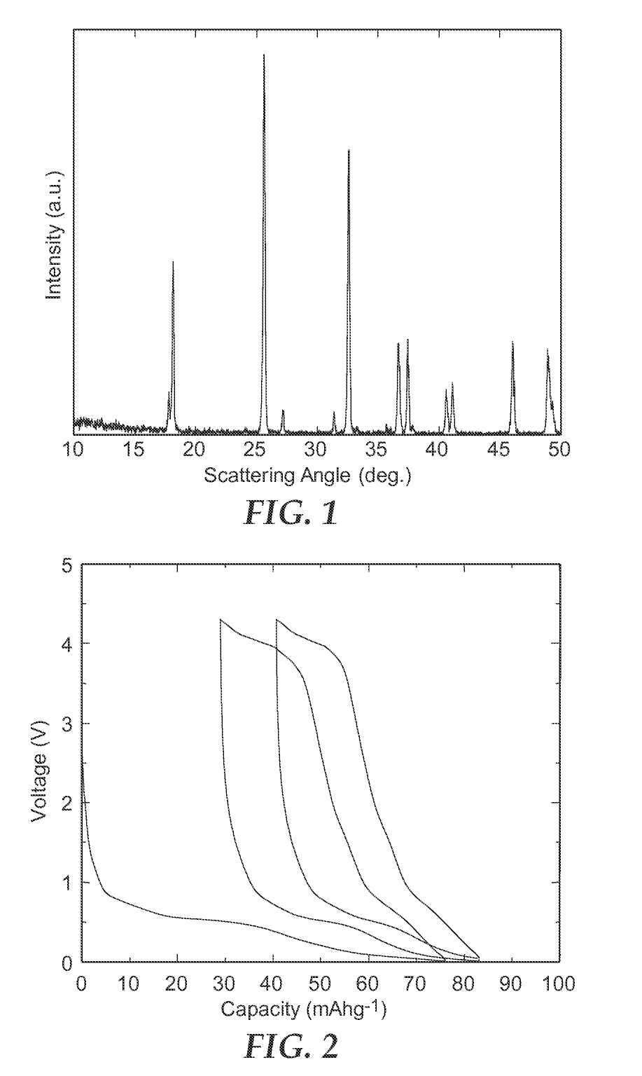

FIG. 1 XRD pattern of Comparative Example 1 Fe₂TiO₅ material with a pseudobrookite structure.

FIG. 2 shows the voltage capacity curve of Comparative Example 1 Fe₂TiO₅ material. It has very low capacity, only 45 mAh/g reversible capacity over a large voltage range.

### Example 1

### Preparation of NiTiO₃ (Ilmenite Structure)

To prepare NiTiO₃, 2.90 g NiO (−325 mesh, 99% Alfa Aesar), and 3.10 g TiO₂ (puriss, 99-100.5%, Sigma-Aldrich) were added to a 40 ml ball milling vial. Stoichiometric amounts of each compound were used. The precursors were ball milled for a half hour in a high energy ball mill (Spex Certiprep). The powders were then heated at 1000° C. in air for 10 hours.

The sample was characterized by X-ray powder diffraction (XRD) using a Rigaku Ultima IV X-Ray Diffractometer equipped with a Cu anode X-ray tube and dual detectors. A scintillation detector with a diffracted beam monochromator was used to measure XRD patterns of powder samples.

Powder XRD samples were loaded into a gas tight X-ray sample holder (DPM Solutions, Hebbville NS) in an argon-filled glovebox. The sample holder had an aluminized Mylar window mounted in an arc such that it was perpendicular to the incident and scattered X-ray beam and did not contribute to the measured XRD patterns. The X-ray sample holder was equipped with gas fittings that allowed a continuous flow of helium gas during the XRD measurements. Rietveld refinement and profile matching of the powder diffraction data of the as prepared powders were performed using Rietica software. By this method it was determined that the prepared NiTiO₃ sample had the ilmenite structure.

2325 type coin cells were assembled to evaluate electrochemical performance in sodium cells. Electrodes consisted of the NiTiO₃ samples, carbon black (Super P, Erachem Europe), and PVDF (polyvinylidene fluoride, Kynar HSV 900) in an 8:1:1 weight ratio. These components were thoroughly mixed in N-methyl-2-pyrrolidone (Sigma Aldrich, anhydrous 99.5%) with two tungsten carbide balls in a Retsch PM200 rotary mill (100 rpm, 1 hour) to create a uniform black slurry. The slurry was then coated onto aluminum foil and dried under vacuum at 120° C. for 2 hours. Circular electrodes, 2 cm² in area, were punched from the resulting coatings. Coin cell preparation was carried out in an argon filled glove box. Sodium foil disk anodes were punched from thin foil (0.015 inch) that was rolled from sodium ingot (Sigma Aldrich, ACS reagent grade). The electrolyte was 1 M NaPF₆ (Sigma Aldrich 98%) dissolved in propylene carbonate (Novolyte Technologies). One Celgard 3501 and one BMF (blown microfiber separator, 3M Company) were used as separators. Cells were tested with a Maccor Series 4000 Automated cycler and were cycled at a constant current of C/10, calculated based on a 173 mAh/g capacity between 0.005 to 4.3 V.

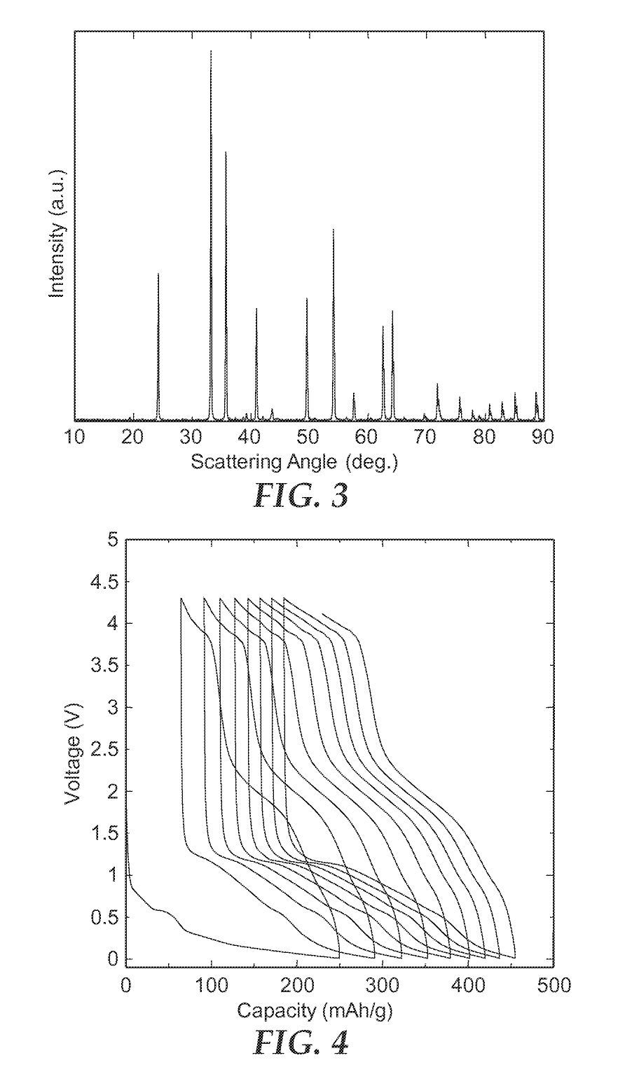

FIG. 3 XRD pattern of Example 1 NiTiO₃ material with an ilmenite structure.

FIG. 4 shows the voltage capacity curve of Example 1 NiTiO₃ material. It displays a reversible capacity of 175 mAh/g. There is a sloping low voltage plateau below 1 volt.

### Sample Preparation

### Examples 2-11

| Example | Composition & Crystal structure |
|---|---|
| Example 2 | CoTiO₃ (ilmenite structure) |
| Example 3 | VFeO₄ (triclinic VFeO₄ structure) |
| Example 4 | Ca₅Co₄(VO₄)₆ (cubic Ca₅Co₄(VO₄)₆ |
| | structure) |
| Example 5 | Co₂V₂O₇ (dichromate structure) |
| Example 6 | CoV₃O₈ (orthorhombic ∀-CoV₃O₈ |
| | structure) |
| Example 7 | MnV₂O₆ (brannerite structure) |
| Example 8 | Mn₂V₂O₇ (thortveitite structure) |
| Example 9 | MnTiO₃ (ilmenite structure) |
| Example 10 | CrVO₄ (orthorhombic ∃-CrPO₄ structure) |
| Example 11 | TiVO₄ (pseudo rutile structure) |

### Example 2

### Preparation of CoTiO₃ (Ilmenite Structure)

2 g of Co₃O₄ (<10 μm, Sigma-Aldrich) and 2 g of TiO₂ (puriss, 99-100.5%, Sigma-Aldrich) were added to a 40 ml ball milling vial. The precursors were ball milled for two hours in a high energy ball mill (Spex Certiprep). The powders were then heated at 800° C. in air for 10 hours.

### Example 3

### VFeO₄ (Triclinic VFeO₄ Structure)

2.13 g of V₂O₅ (>99.6%, Sigma-Aldrich) and 1.87 g of Fe₂O₃ (<5 μm, >99%, Sigma-Aldrich) were added to a 40 ml ball milling vial. The precursors were ball milled for one hour in a high energy ball mill (Spex Certiprep). The powders were then heated at 550° C. in air for 24 hours.

### Example 4

### Preparation of Ca₅Co₄(VO₄)₆ (Cubic Ca₅Co₄(VO₄)₆ Structure)

0.725 g of CaO (99.9%, Sigma-Aldrich), 0.956 g of CoO (−325 mesh, Sigma-Aldrich) and 2.319 g of V₂O₅ (>99.6%, Sigma-Aldrich) were added to a 40 ml ball milling vial. The precursors were ball milled for one hour in argon in a high energy ball mill (Spex Certiprep). The powders were then heated at 750° C. in argon for 10 hours. After synthesis, the powder was transferred directly to an argon filled glove box without air exposure.

### Example 5

### Preparation of Co₂V₂O₇ (Dichromate Structure)

1.88 g of Co₃O₄ (<10 μm, Sigma-Aldrich) and 2.12 g of V₂O₅ (>99.6%, Sigma-Aldrich) were added to a 40 ml ball milling vial. The precursors were ball milled for one hour in a high energy ball mill (Spex Certiprep). The powders were then heated at 600° C. in air for 30 hours.

### Example 6

### Preparation of CoV₃O₈ (Orthorhombic ∀-CoV₃O₈ Structure)

0.88 g of CoO (−325 mesh, Sigma-Aldrich), 0.98 g of V₂O₄ (99.9% trace metals basis) and 2.14 g of V₂O₅ (>99.6%, Sigma-Aldrich) were added to a 40 ml ball milling vial. The precursors were ball milled for one hour in argon a high energy ball mill (Spex Certiprep). The powders were then heated at 600° C. in argon for 12 hours. After synthesis, the powder was transferred directly to an argon filled glove box without air exposure.

### Example 7

### Preparation of MnV₂O₆ (Brannerite Structure)

1.21 g of Mn₂O₃ (−325 mesh, 99%, Sigma-Aldrich) and 2.79 g of V₂O₅ (>99.6%, Sigma-Aldrich) were added to a 40 ml ball milling vial. The precursors were ball milled for one hour in a high energy ball mill (Spex Certiprep). The powders were then heated at 600° C. in air for 30 hours.

### Example 8

### Preparation of Mn₂V₂O₇ (Thortveitite Structure)

1.75 g of MnO (−60 mesh, 99%, Sigma-Aldrich) and 2.25 g of V₂O₅ (>99.6%, Sigma-Aldrich) were added to a 40 ml ball milling vial. The precursors were ball milled for one hour in a high energy ball mill (Spex Certiprep). The powders were then heated at 800° C. in air for 30 hours.

### Example 9

### Preparation of MnTiO₃ (Ilmenite Structure)

3.13 g of MnO₂ (60-230 mesh, >99%, Sigma-Aldrich) and 2.87 g of TiO₂ (puriss, 99-100.5%, Sigma-Aldrich) were added to a 40 ml ball milling vial. The precursors were ball milled for one hour in argon in a high energy ball mill (Spex Certiprep). The powders were then heated at 1100° C. in argon for 10 hours. After synthesis, the powder was transferred directly to an argon filled glove box without air exposure.

### Example 10

### Preparation of CrVO₄ (Orthorhombic ∃-CrPO₄ Structure)

1.82 g of Cr₂O₃ (50 μm, >98%, Sigma-Aldrich) and 2.18 g of V₂O₅ (>99.6%, Sigma-Aldrich) were added to a 40 ml ball milling vial. The precursors were ball milled for one hour in a high energy ball mill (Spex Certiprep). The powders were then heated at 800° C. in air for 30 hours.

### Example 11

### Preparation of TiVO₄ (Pseudo Rutile Structure)

2.94 g of TiO₂ (puriss, 99-100.5%, Sigma-Aldrich) and 3.06 g of V₂O₅ (>99.6%, Sigma-Aldrich) were added to a 40 ml ball milling vial. The precursors were ball milled for 30 minutes in argon in a high energy ball mill (Spex Certiprep). The powders were then heated at 1000° C. in argon for 16 hours. After synthesis, the powder was transferred directly to an argon filled glove box without air exposure.

### Characterization and Evaluation

### Examples 2-11

Examples 2-11 were characterized by X-ray powder diffraction (XRD) using a Rigaku Ultima IV X-Ray Diffractometer equipped with a Cu anode X-ray tube and dual detectors. A scintillation detector with a diffracted beam monochromator was used to measure XRD patterns of powder samples.

Using the materials prepared in Examples 2-11, 2325 type coin cells were assembled to evaluate electrochemical performance in sodium cells. Electrodes consisted of the sample, carbon black (Super P, Erachem Europe), and PVDF (polyvinylidene fluoride, Kynar HSV 900) in an 8:1:1 weight ratio. These components were thoroughly mixed in N-methyl-2-pyrrolidone (Sigma Aldrich, anhydrous 99.5%) with two tungsten carbide balls in a Retsch PM200 rotary mill (100 rpm, 1 hour) to create a uniform black slurry. The slurry was then coated onto aluminum or copper foil and dried under vacuum at 120° C. for 2 hours. Circular electrodes, 2 cm² in area, were punched from the resulting coatings. Coin cell preparation was carried out in an argon filled glove box. Sodium foil disk anodes were punched from thin foil (0.015 inch) that was rolled from sodium ingot (Sigma Aldrich, ACS reagent grade). The electrolyte was 1 M NaPF₆ (Sigma Aldrich 98%) dissolved in 3/6/1 ethylene carbonate/diethyl carbonate/monofluoroethylene carbonate (all from Novolyte Technologies). Two Celgard 2300 and one BMF (blown microfiber separator, 3M Company) were used as separators. Cells were tested on a Maccor Series 4000 Automated cycler and were cycled at constant current rates of C/10 and C/40 with a trickle discharge to C/20 and C/80, respectively, calculated based on capacities between 100-200 mAh/g for cycling from 0.005 to 2.5 V and/or 0.005 to 4.5 V.

### Experimental Results

### Examples 2-11

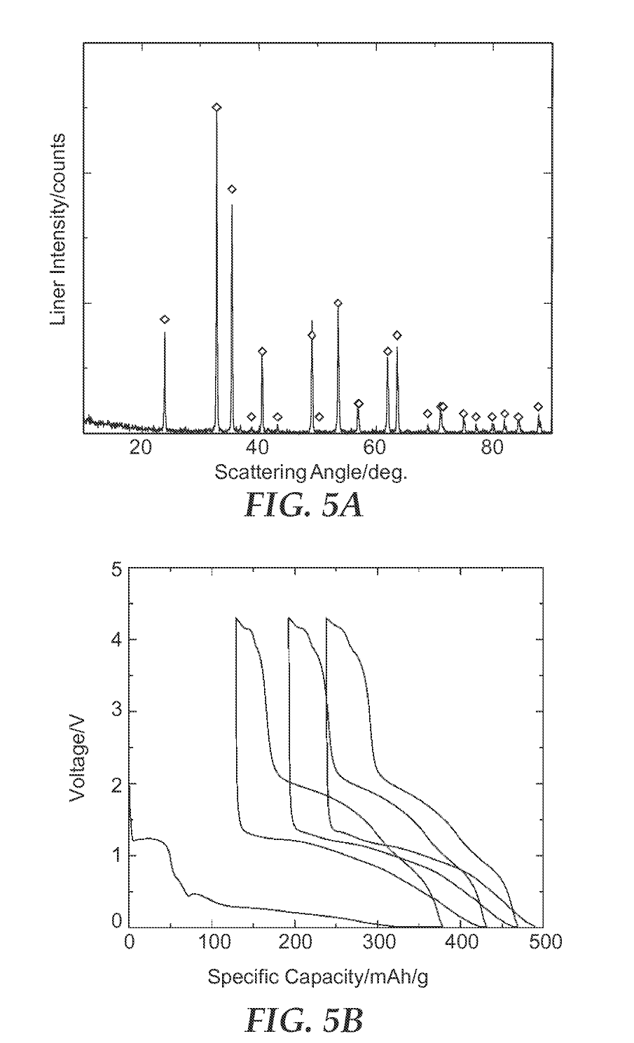

FIG. 5 shows the experimental XRD pattern of Example 2 compared with the literature pattern of CoTiO₃ (top) and the corresponding voltage curve for cell made with Example 2 material (bottom). Example 2 is phase pure CoTiO₃ with the R-3 (148) space group (ilmenite structure). This material has reversible low average voltage capacity showing potential for use as a negative electrode material in sodium ion batteries.

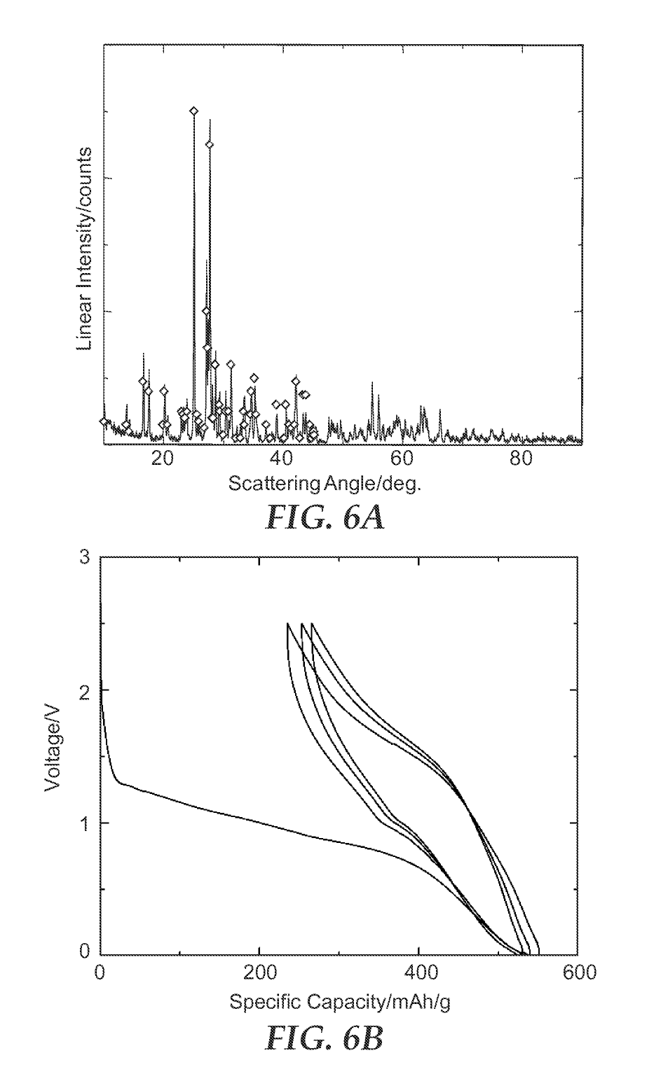

FIG. 6 shows the experimental XRD pattern of Example 3 compared with the literature pattern of VFeO₄ (top) and the corresponding voltage curve for cell made with Example 3 material (bottom). Example 3 is phase pure VFeO₄ with the P-1 (2) space group (triclinic VFeO₄ structure). This material has reversible low average voltage capacity showing potential for use as a negative electrode material in sodium ion batteries.

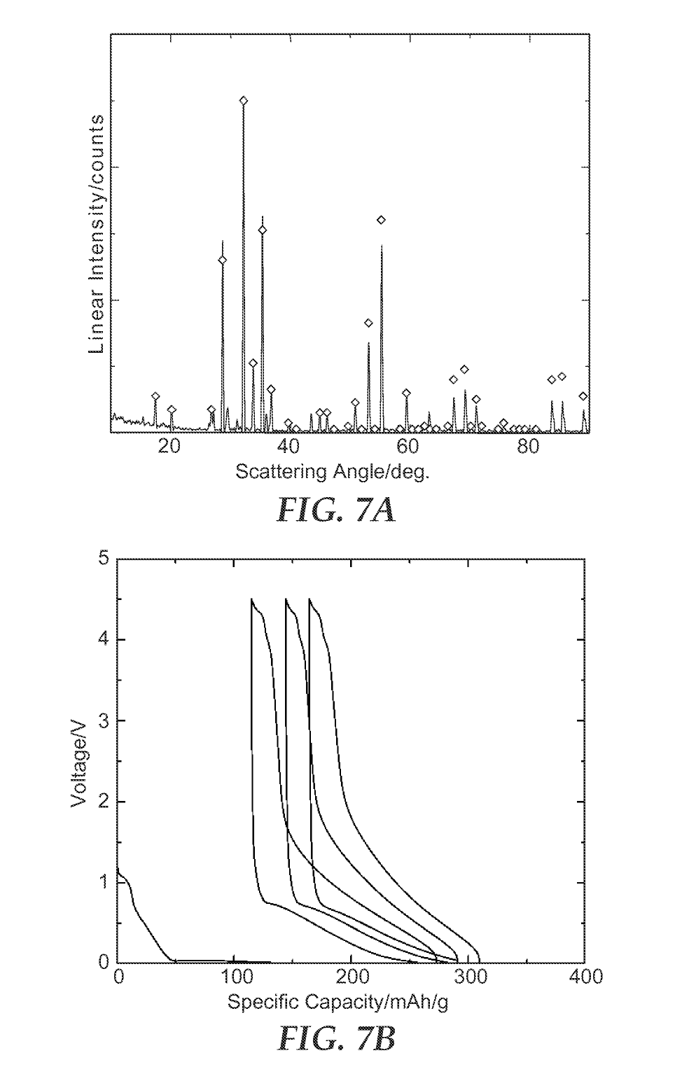

FIG. 7 shows the experimental XRD pattern of Example 4 compared with the literature pattern of Ca₅Co₄(VO₄)₆ (top) and the corresponding voltage curve for cell made with Example 4 material (bottom). A phase pure was not obtained; the Ca₅Co₄(VO₄)₆ phase with the Ia-3d (230) space group (cubic Ca₅Co₄(VO₄)₆ structure) is present with a minor Co₃V₂O₈ impurity. This material has reversible low average voltage capacity showing potential for use as a negative electrode material in sodium ion batteries.

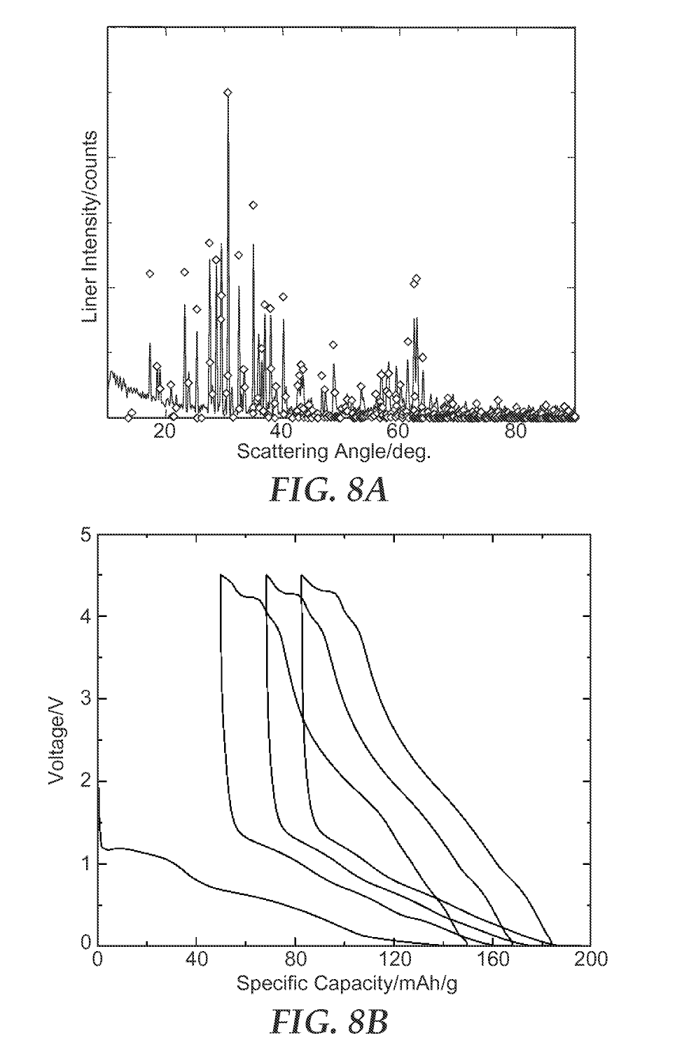

FIG. 8 shows the experimental XRD pattern of Example 5 compared with the literature pattern of Co₂V₂O₇ (top) and the corresponding voltage curve for cell made with Example 5 material (bottom). Example 5 is phase pure Co₂V₂O₇ with the P21/c (14) space group (dichromate structure). This material has reversible low average voltage capacity showing potential for use as a negative electrode material in sodium ion batteries.

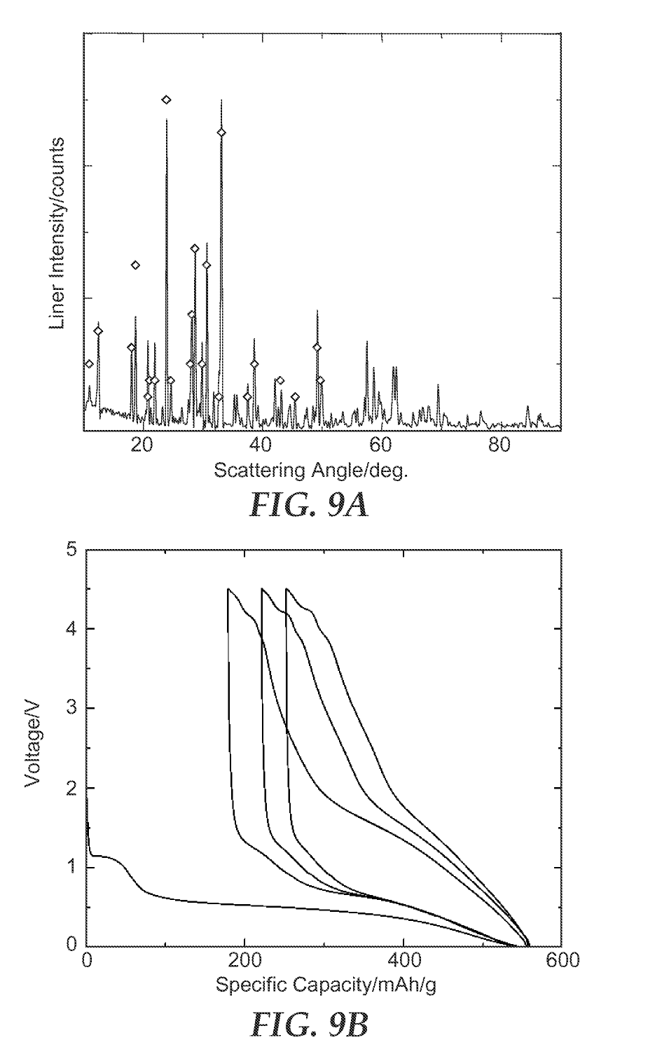

FIG. 9 shows the experimental XRD pattern of Example 6 compared with the literature pattern of CoV₃O₈ (top) and the corresponding voltage curve for cell made with Example 6 material (bottom). A phase pure was not obtained; the CoV₃O₈ phase with the Cmce (64) space group (orthorhombic ∀-CoV₃O₈ structure) is present with minor cobalt/vanadium oxide impurities. This material has reversible low average voltage capacity showing potential for use as a negative electrode material in sodium ion batteries.

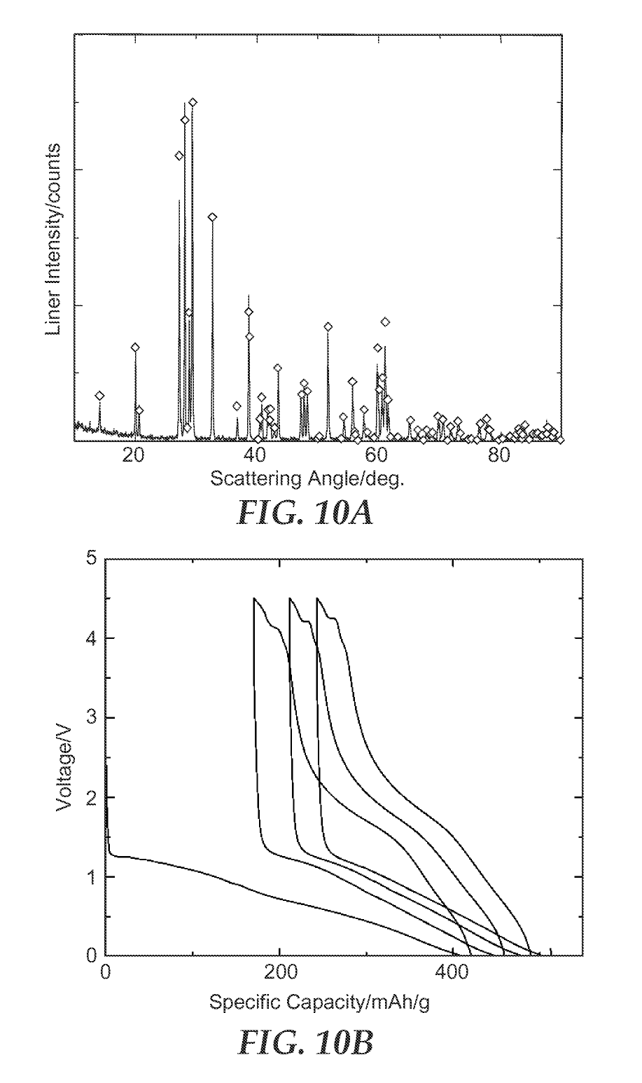

FIG. 10 shows the experimental XRD pattern of Example 7 compared with the literature pattern of MnV₂O₆ (top) and the corresponding voltage curve for cell made with Example 7 material (bottom). Example 7 is phase pure MnV₂O₆ with the C2/m (12) space group (brannerite structure). This material has reversible low average voltage capacity showing potential for use as a negative electrode material in sodium ion batteries.

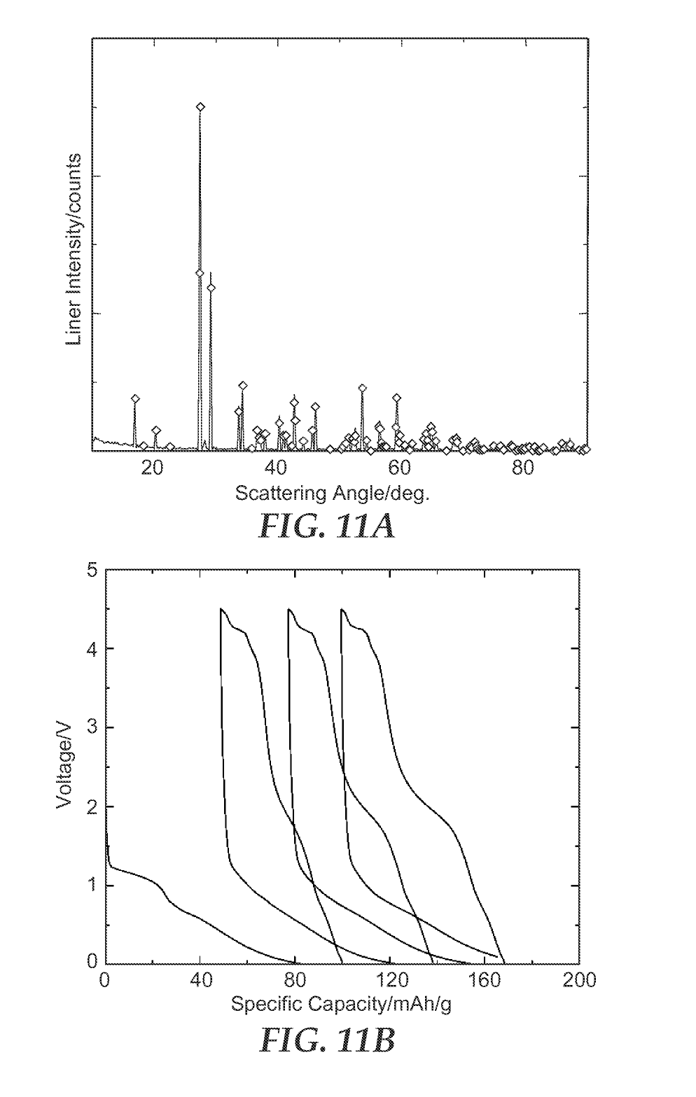

FIG. 11 shows the experimental XRD pattern of Example 8 compared with the literature pattern of Mn₂V₂O₇ (top) and the corresponding voltage curve for cell made with Example 8 material (bottom). Example 8 is phase pure Mn₂V₂O₇ with the C2/m (12) space group (thortveitite structure). This material has reversible low average voltage capacity showing potential for use as a negative electrode material in sodium ion batteries.

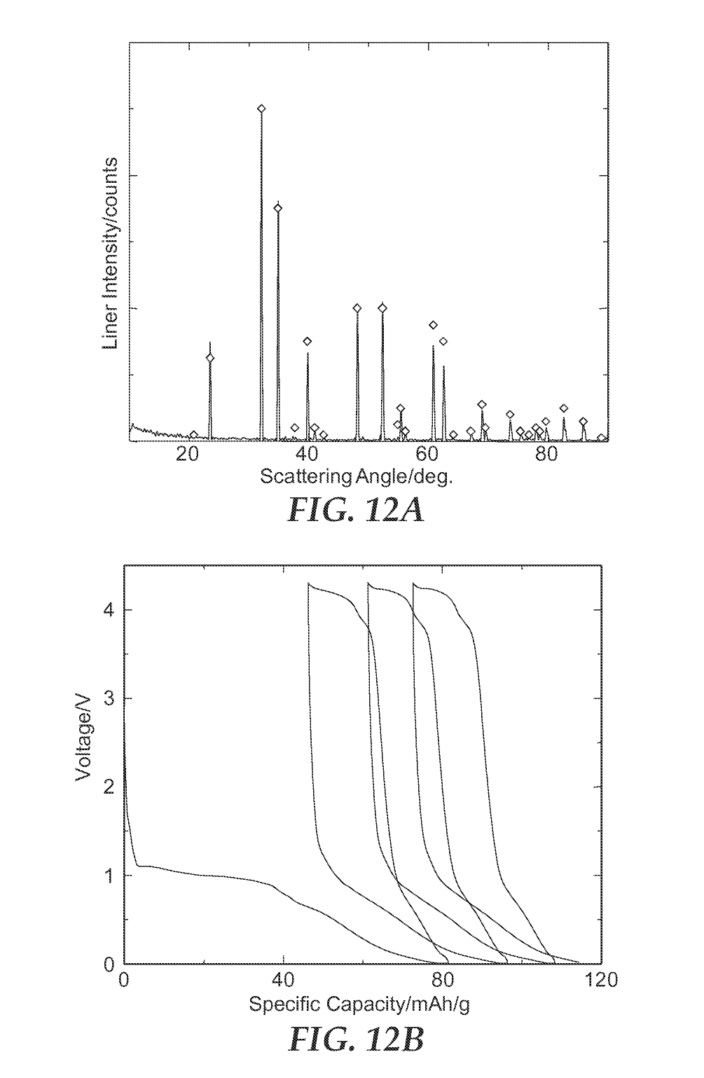

FIG. 12 shows the experimental XRD pattern of Example 9 compared with the literature pattern of MnTiO₃ (top) and the corresponding voltage curve for cell made with Example 9 material (bottom). Example 9 is phase pure MnTiO₃ with the R-3 (148) space group (ilmenite structure). This material has reversible low average voltage capacity showing potential for use as a negative electrode material in sodium ion batteries.

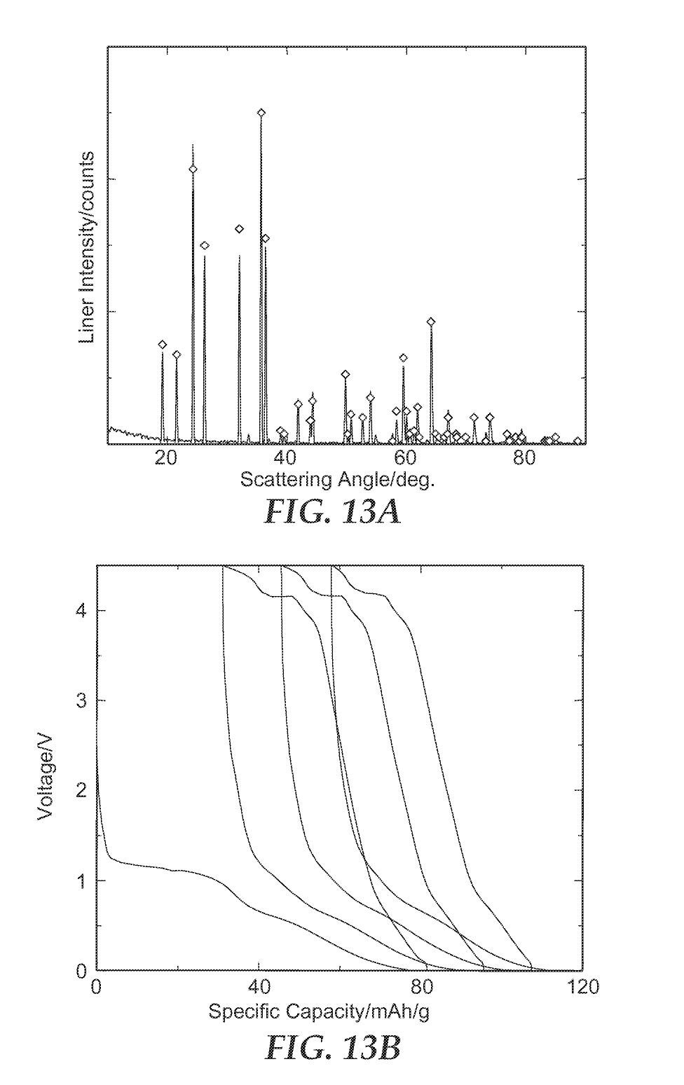

FIG. 13 shows the experimental XRD pattern of Example 10 compared with the literature pattern of CrVO₄ (top) and the corresponding voltage curve for cell made with Example 10 material (bottom). Example 10 is phase pure CrVO₄ with the Cmcm (63) space group (orthorhombic ∃-CrPO₄ structure) is present with a minor unidentified impurity. This material has reversible low average voltage capacity showing potential for use as a negative electrode material in sodium ion batteries.

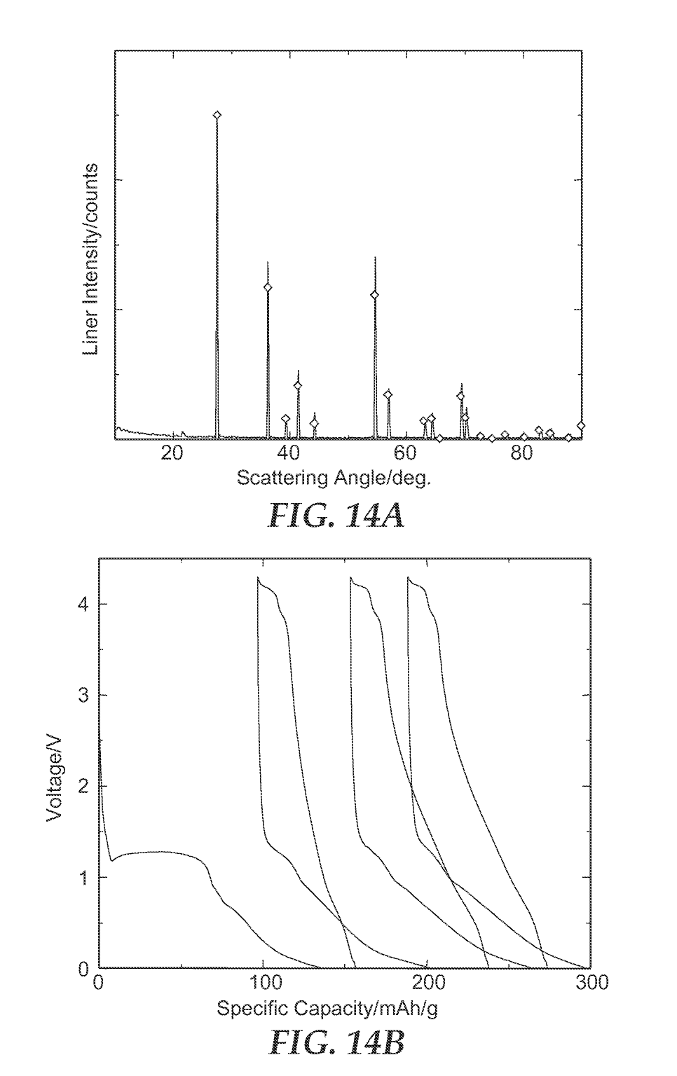

FIG. 14 shows the experimental XRD pattern of Example 11 compared with the literature pattern of TiVO₄ (top) and the corresponding voltage curve for cell made with Example 11 material (bottom). Example 11 is phase pure TiVO₄ with the P42/mmm (136) space group (pseudo rutile structure). This material has reversible low average voltage capacity showing potential for use as a negative electrode material in sodium ion batteries.

1. A sodium-ion battery comprising:
a cathode comprising sodium; and
an anode composition comprising a material having the formula:
AₐB_{b}C_{c}D_{d}O, (I)
where A is an alkali metal, alkaline earth metal, or a combination thereof, where B is titanium, C is vanadium, D is one or more transition metal element other than titanium or vanadium, a+b+c+d≦1, a≧0, b+c>0, b≧0, c≧0, d>0, and where the material comprises a ilmenite structure, triclinic VFeO₄ structure, cubic Ca₅Co₄(VO₄)₆ structure, dichromate structure, orthorhombic ∀-CoV₃O₈ structure, brannerite structure, thortveitite structure, orthorhombic ∃-CrPO₄ structure, or the pseudo rutile structure.

2. The sodium-ion battery of claim 1, wherein (b+c)/d≧1.

3. The sodium-ion battery of claim 1, wherein b=0.

4. The sodium-ion battery of claim 1, wherein c=0.

5. The sodium-ion battery of claim 1, wherein b>0 and c>0.

6. The sodium-ion battery according to claim 1, wherein a>0.05.

7. The sodium-ion battery according to claim 1, wherein D is iron, nickel, cobalt, manganese, chromium, or combinations thereof.

8. A sodium-ion battery comprising:
a cathode comprising sodium; and
an anode composition comprising a material having the formula:
A′ₑB′_{f}C′_{g}O, (II)
where A′ is an alkali metal, alkaline earth metal, or a combination thereof, where B′ is titanium, C′ is vanadium, e+f+g≦1, e≧0, f>0, and g>0.

9. The sodium-ion battery according to claim 8, wherein A or A′ is sodium, lithium, magnesium, calcium, or combinations thereof.

10. The sodium-ion battery according to claim 8, wherein the sodium-ion battery further comprises an electrolyte comprising sodium.

11. An electronic device comprising a sodium-ion battery according to claim 8.

12. A method of making a sodium-ion battery, the method comprising:
providing a cathode comprising sodium;
providing an anode comprising vanadium, titanium or a combination thereof, and optionally an alkali metal or alkaline earth metal and optionally a transition metal other than titanium or vanadium; and
incorporating the cathode and anode into a battery comprising an electrolyte, wherein the electrolyte comprises sodium.

13. A sodium-ion battery comprising:
a cathode comprising sodium; and
an anode composition comprising one or more materials selected from CoTiO₃, Ca₅Co₄(VO₄)₆, CoV₃O₈, NiTiO₃, or Co₂V₂O₇.
